(19) United States
(12) Patent Application Publication
(10) Pub. No.: US 2025/0078805 A1
(43) Pub. Date: Mar. 6, 2025

(54) Scaling Multilingual Speech Synthesis with Zero Supervision of Found Data

(71) Applicant: Google LLC, Mountain View, CA (US)

(72) Inventors: Andrew M Rosenberg, Brooklyn, NY (US); Takaaki Saeki, Mountain View, CA (US); Francoise Beaufays, Mountain View, CA (US); Bhuvana Ramabhadran, Mt. Kisoo, NY (US)

(73) Assignee: Google LLC, Mountain View, CA (US)

(21) Appl. No.: 18/823,661

(22) Filed: Sep. 3, 2024

Related U.S. Application Data
(60) Provisional application No. 63/580,706, filed on Sep. 5, 2023.

(51) Int. Cl. G10L 13/02; G10L 25/30

(52) U.S. Cl. CPC G10L 13/02; G10L 25/30

(57) ABSTRACT

A method includes receiving training data that includes a plurality of sets of training utterances each associated with a respective language. Each training utterance includes a corresponding reference speech representation paired with a corresponding input text sequence. For each training utterance, the method includes generating a corresponding encoded textual representation for the corresponding input text sequence, generating a corresponding speech encoding for the corresponding reference speech representation, generating a shared encoder output, and determining a text-to-speech (TTS) loss based on the corresponding encoded textual representation, the corresponding speech encoding, and the shared encoder output. The method also includes training a TTS model based on the TTS losses determined for the training utterances in each set of the training utterances to teach the TTS model to learn how to synthesize speech in each of the respective languages.

### CROSS REFERENCE TO RELATED APPLICATIONS

This U.S. patent application claims priority under 35 U.S.C. § 119 (e) to U.S. Provisional Application 63/580,706, filed on Sep. 5, 2023. The disclosure of this prior application is considered part of the disclosure of this application and is hereby incorporated by reference in its entirety.

### TECHNICAL FIELD

This disclosure relates to scaling multilingual speech synthesis with zero supervision of found data.

### BACKGROUND

Text-to-speech (TTS) systems read aloud digital text to a user and are becoming increasingly popular on mobile devices. Certain TTS models aim to synthesize various aspects of speech, such as speaking styles and languages, to produce human-like, natural sounding speech. Some TTS models are multilingual such that the TTS model outputs synthetic speech in multiple different languages. However, even these multilingual TTS models are only compatible with a relatively small portion of all the languages spoken in the world. Particularly, a lack of sufficient training data in other languages, especially low-resource languages, inhibits TTS models from learning to generate synthetic speech in these other languages. As such, training a multilingual TTS model to generate synthetic speech in many different languages, even for low-resource languages, would further increase the use of TTS models.

### SUMMARY

One aspect of the disclosure provides a computer-implemented method that when executed on data processing hardware causes the data processing hardware to perform operations for scaling multilingual speech synthesis with zero supervision of found data. The operations include receiving training data that includes a plurality of sets of training utterances. Each set of training utterances is associated with a respective language that is different than the respective language associated with each other set of the training utterances and includes speech spoken in the respective language. Each training utterance includes a corresponding reference speech representation paired with a corresponding input text sequence. For each training utterance in each set of training utterances of the received training data, the operations include generating a corresponding encoded textual representation for the corresponding input text sequence using a text encoder, generating a corresponding speech encoding for the corresponding reference speech representation using a speech encoder, generating a shared encoder output using a shared encoder configured to receive the corresponding encoded textual representation or the corresponding speech encoding, and determining a text-to-speech (TTS) loss based on the corresponding encoded textual representation, the corresponding speech encoding, and the shared encoder output. The operations also include training a TTS model based on the TTS losses determined for the training utterances in each set of the training utterances to teach the TTS model to learn how to synthesize speech in each of the respective languages.

Implementations of the disclosure may include one or more of the following optional features. In some implementations, for each training utterance in each set of the training utterances of the received training data, the operations further include obtaining a corresponding speaker embedding characterizing speaker characteristics of a corresponding speaker that spoke the training utterance in the respective language and obtaining a corresponding language embedding identifying the respective language of the utterance. Here, the text encoder is configured to receive a concatenation of the corresponding speaker embedding and the corresponding language embedding. In some examples, for each training utterance in each set of the training utterances of the received training data, the operations further include generating a speech recognition hypothesis representing a candidate transcription for the corresponding training utterance using an automatic speech recognition (ASR) decoder configured to receive the shared encoder output as input and determining an ASR loss based on the speech recognition hypothesis and the corresponding input text sequence. Here, the TTS loss includes the ASR loss. In these examples, the ASR decoder includes a recurrent neural network-transducer (RNN-T) architecture.

In some implementations, for each training utterance in each set of the training utterances of the received training data, the operations further include determining a feature loss between the encoded textual representation generated for the corresponding input text sequence using the text encoder and the speech encodings generated for the corresponding reference speech representation using the speech encoder. Here, the TTS loss includes the feature loss. In some examples, for each training utterance in each set of the training utterances of the received training data, the operations further include obtaining a sequence representation of the corresponding input text sequence concatenated with a variational embedding, predicting a duration of the input text sequence based on the sequence representation using a duration model, upsampling the sequence representation into an upsampled output specifying a number of frames using the duration model, and determining a duration loss based on the predicted duration of the input text sequence and a ground-truth duration. Here, the TTS loss includes the duration loss.

In some implementations, the training data further includes unspoken textual utterances associated with a respective plurality of different languages where each unspoken textual utterance is not paired with any corresponding spoken utterance and the operations further include, for each unspoken textual utterance, generating a corresponding unspoken encoded textual representation for the corresponding unspoken textual utterance using the text encoder and determining an aligned-text masked language modeling (MLM) loss for the corresponding unspoken encoded textual representation generated for the corresponding unspoken textual utterance. Here, the TTS loss includes the aligned-text MLM loss. In these implementations, each unspoken textual utterances may be paired with a corresponding language identifier label and the operations further include, for each unspoken textual utterance, generating a predicted language identifier using a language identifier configured to receive the corresponding unspoken encoded textual representation generated for the corresponding unspoken textual utterance as input and determining a text language identifier loss based on the predicted language identifier and the language identifier label. Here, the TTS loss includes the text language identifier loss. In some examples, the training data further includes unpaired spoken utterances spoken in a respective plurality of different languages where each unpaired spoken utterance is not paired with any corresponding text and the operations further include, for each unpaired spoken utterance, generating a corresponding unpaired speech encoding for the corresponding unpaired spoken utterance using the speech encoder and determining an aligned-speech masked language modeling (MLM) loss for the corresponding unpaired speech encoding generated for the corresponding unpaired spoken utterance. Here, the TTS loss includes the aligned-speech MLM loss. In these examples, for each unpaired spoken utterance, the operations may further include generating an unpaired shared encoder output using the shared encoder further configured to receive the corresponding unpaired speech encoding and generating a pseudolabel representing a candidate transcription for the corresponding unpaired spoken utterance using an automatic speech recognition (ASR) decoder configured to receive the unpaired shared encoder output as input. Here, the training data further includes unspoken textual utterances including the pseudolabels.

In these examples, each unpaired spoken utterance may be paired with a corresponding language identifier label and the operations further include, for each unpaired spoken utterance, generating a predicted language identifier using a language identifier configured to receive the corresponding unpaired speech encoding for the corresponding unpaired spoken utterance as input and determining a speech language identifier loss based on the predicted language identifier and the language identifier label. Here, the TTS loss includes the speech language identifier loss. Each corresponding input text sequence may include a sequence of graphemes, word-piece-model units, phonemes, or bytes. In some examples, generating the speech encoding for the corresponding reference speech representation includes applying random projections to project the corresponding utterance using a random-projection quantizer and mapping the corresponding projected utterance to discrete labels.

Another aspect of the disclosure provides a system that includes data processing hardware and memory hardware storing instructions that when executed on the data processing hardware causes the data processing hardware to perform operations. The operations include receiving training data that includes a plurality of sets of training utterances. Each set of training utterances is associated with a respective language that is different than the respective language associated with each other set of the training utterances and includes speech spoken in the respective language. Each training utterance includes a corresponding reference speech representation paired with a corresponding input text sequence. For each training utterance in each set of training utterances of the received training data, the operations include generating a corresponding encoded textual representation for the corresponding input text sequence using a text encoder, generating a corresponding speech encoding for the corresponding reference speech representation using a speech encoder, generating a shared encoder output using a shared encoder configured to receive the corresponding encoded textual representation or the corresponding speech encoding, and determining a text-to-speech (TTS) loss based on the corresponding encoded textual representation, the corresponding speech encoding, and the shared encoder output. The operations also include training a TTS model based on the TTS losses determined for the training utterances in each set of the training utterances to teach the TTS model to learn how to synthesize speech in each of the respective languages.

Implementations of the disclosure may include one or more of the following optional features. In some implementations, for each training utterance in each set of the training utterances of the received training data, the operations further include obtaining a corresponding speaker embedding characterizing speaker characteristics of a corresponding speaker that spoke the training utterance in the respective language and obtaining a corresponding language embedding identifying the respective language of the utterance. Here, the text encoder is configured to receive a concatenation of the corresponding speaker embedding and the corresponding language embedding. In some examples, for each training utterance in each set of the training utterances of the received training data, the operations further include generating a speech recognition hypothesis representing a candidate transcription for the corresponding training utterance using an automatic speech recognition (ASR) decoder configured to receive the shared encoder output as input and determining an ASR loss based on the speech recognition hypothesis and the corresponding input text sequence. Here, the TTS loss includes the ASR loss. In these examples, the ASR decoder includes a recurrent neural network-transducer (RNN-T) architecture.

In some implementations, for each training utterance in each set of the training utterances of the received training data, the operations further include determining a feature loss between the encoded textual representation generated for the corresponding input text sequence using the text encoder and the speech encodings generated for the corresponding reference speech representation using the speech encoder. Here, the TTS loss includes the feature loss. In some examples, for each training utterance in each set of the training utterances of the received training data, the operations further include obtaining a sequence representation of the corresponding input text sequence concatenated with a variational embedding, predicting a duration of the input text sequence based on the sequence representation using a duration model, upsampling the sequence representation into an upsampled output specifying a number of frames using the duration model, and determining a duration loss based on the predicted duration of the input text sequence and a ground-truth duration. Here, the TTS loss includes the duration loss.

In some implementations, the training data further includes unspoken textual utterances associated with a respective plurality of different languages where each unspoken textual utterance is not paired with any corresponding spoken utterance and the operations further include, for each unspoken textual utterance, generating a corresponding unspoken encoded textual representation for the corresponding unspoken textual utterance using the text encoder and determining an aligned-text masked language modeling (MLM) loss for the corresponding unspoken encoded textual representation generated for the corresponding unspoken textual utterance. Here, the TTS loss includes the aligned-text MLM loss. In these implementations, each unspoken textual utterances may be paired with a corresponding language identifier label and the operations further include, for each unspoken textual utterance, generating a predicted language identifier using a language identifier configured to receive the corresponding unspoken encoded textual representation generated for the corresponding unspoken textual utterance as input and determining a text language identifier loss based on the predicted language identifier and the language identifier label. Here, the TTS loss includes the text language identifier loss. In some examples, the training data further includes unpaired spoken utterances spoken in a respective plurality of different languages where each unpaired spoken utterance is not paired with any corresponding text and the operations further include, for each unpaired spoken utterance, generating a corresponding unpaired speech encoding for the corresponding unpaired spoken utterance using the speech encoder and determining an aligned-speech masked language modeling (MLM) loss for the corresponding unpaired speech encoding generated for the corresponding unpaired spoken utterance. Here, the TTS loss includes the aligned-speech MLM loss. In these examples, for each unpaired spoken utterance, the operations may further include generating an unpaired shared encoder output using the shared encoder further configured to receive the corresponding unpaired speech encoding and generating a pseudolabel representing a candidate transcription for the corresponding unpaired spoken utterance using an automatic speech recognition (ASR) decoder configured to receive the unpaired shared encoder output as input. Here, the training data further includes unspoken textual utterances including the pseudolabels.

In these examples, each unpaired spoken utterance may be paired with a corresponding language identifier label and the operations further include, for each unpaired spoken utterance, generating a predicted language identifier using a language identifier configured to receive the corresponding unpaired speech encoding for the corresponding unpaired spoken utterance as input and determining a speech language identifier loss based on the predicted language identifier and the language identifier label. Here, the TTS loss includes the speech language identifier loss. Each corresponding input text sequence may include a sequence of graphemes, word-piece-model units, phonemes, or bytes. In some examples, generating the speech encoding for the corresponding reference speech representation includes applying random projections to project the corresponding utterance using a random-projection quantizer and mapping the corresponding projected utterance to discrete labels.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example speech recognition system.

FIG. 2 is a schematic view of an example automatic speech recognition model.

FIGS. 3A-3E are schematic views of an example training process for training a text-to-speech (TTS) model using sets of training utterances.

FIG. 4 is a schematic view of an example alignment model used during the example training process.

FIG. 5 is a schematic view of an example training process for the alignment model.

FIG. 6 is a flowchart of an example arrangement of operations for a method of scaling multilingual speech synthesis with zero supervision of found data.

FIG. 7 is a schematic view of an example computing device that may be used to implement the systems and methods described herein.

Like reference symbols in the various drawings indicate like elements.

### DETAILED DESCRIPTION

Text-to-speech is the process generating synthetic speech based on input textual data. In some instances, TTS models are multilingual whereby the TTS model may receive a text input and generate synthetic speech corresponding to the text input in multiple different languages. Recently, TTS models have made significant advances in synthesizing human-like high-quality speech in multiple languages. Yet, even multilingual TTS models are only capable of generating synthetic speech in a few different languages. A major obstacle preventing TTS models from scaling to hundreds or even thousands of different languages is the difficulty in collecting a large quantity of high-quality paired training data in each of the different languages that is required to train the TTS model. In particular, low-resource languages have a very scarce amount of (or even zero) paired training data thereby further increasing the difficulty of scaling TTS models to these low-resource languages.

Accordingly, implementations herein are directed towards methods and systems for training a massive multilingual TTS model. That is, a training process may receive training data that includes a plurality of sets of training utterances. Each set of training utterances is associated with a respective language that is different than the respective language associated with each other set of the training utterances and includes speech spoken in the respective language. Each training utterance includes a corresponding reference speech representation paired with a corresponding input text sequence. For each training utterance in each set of training utterances, the training process generates a corresponding encoded textual representation for the corresponding input text sequence, generates a corresponding speech encoding for the corresponding reference speech representation, generates a shared encoder output, and determines a text-to-speech (TTS) loss based on the corresponding encoded textual representation, the corresponding speech encoding, and the shared encoder output. The training process also includes training a TTS model based on the TTS losses determined for the training utterances in each set of the training utterances to teach the TTS model to learn how to synthesize speech in each of the respective languages. Notably, the training process may employ one or more components (e.g., speech encoder and/or text encoder) of an automatic speech recognition (ASR) model to train the multilingual TTS model. In some examples, the ASR model and the TTS model share the same text encoder. In other examples, the ASR model and the TTS model each include a respective text encoder.

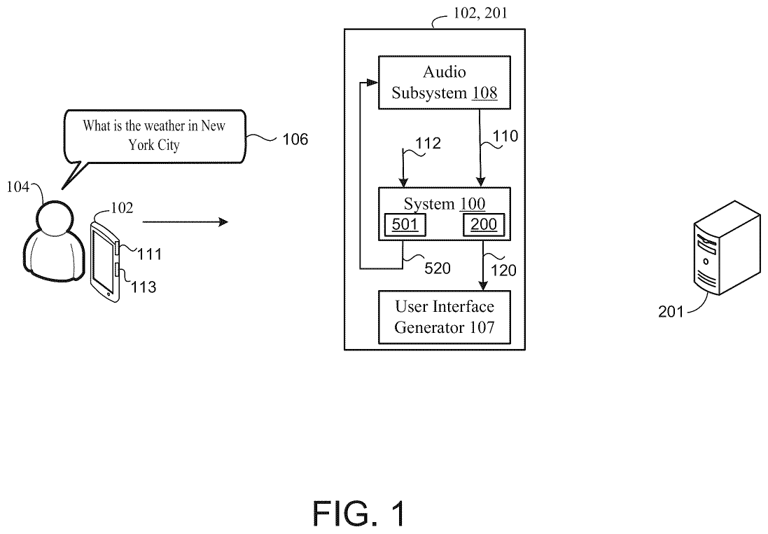

FIG. 1 illustrates an example system 100 implementing an automated speech recognition (ASR) model 200 and a text-to-speech (TTS) model 501 that resides on a user device 102 associated with a user 104 and/or on a remote computing device 201 (e.g., one or more servers of a distributed system executing in a cloud-computing environment) in communication with the user device 102. Although the user device 102 is depicted as a mobile computing device (e.g., a smart phone), the user device 102 may correspond to any type of computing device such as, without limitation, a tablet device, a laptop/desktop computer, a wearable device, a digital assistant device, a smart speaker/display, a smart appliance, an automotive infotainment system, or an Internet-of-Things (IoT) device, and is equipped with data processing hardware 111 and memory hardware 113.

The user device 102 includes an audio subsystem 108 configured to receive an utterance 106 spoken by the user 104 (e.g., the user device 102 may include one or more microphones for recording the spoken utterance 106) and convert the utterance 106 into a corresponding digital format associated with input acoustic frames 110 capable of being processed by the ASR system 100. In the example shown, the user speaks a respective utterance 106 in a natural language of English for the phrase “What is the weather in New York City?” and the audio subsystem 108 converts the utterance 106 into corresponding acoustic frames 110 for input to the ASR system 100. Thereafter, the ASR model 200 receives, as input, the acoustic frames 110 corresponding to the utterance 106, and generates/predicts, as output, a corresponding transcription 120 (e.g., recognition result/hypothesis) of the utterance 106. In the example shown, the user device 102 and/or the remote computing device 201 also executes a user interface generator 107 configured to present a representation of the transcription 120 of the utterance 106 to the user 104 of the user device 102. In some configurations, the transcription 120 output from the ASR system 100 is processed, e.g., by a natural language understanding (NLU) module executing on the user device 102 or the remote computing device 201, to execute a user command. Additionally or alternatively, the TTS model 501 (e.g., executing on any combination of the user device 102 or the remote computing device 201) may convert the transcription 120 into synthesized speech for audible output by the audio subsystem 108 or another device. For instance, the original utterance 106 may correspond to a message the user 104 is sending to a friend in which the transcription 120 is converted to synthesized speech for audible output to the friend to listen to the message conveyed in the original utterance 106.

The TTS model 501 receives, as input, a textual input 112 corresponding to a word or sequence of words and generates, as output, a corresponding speech representation 520 for the textual input. In particular, the TT'S model 501 may generate textual encodings based on the textual input 112 and decode the textual encodings 520 to produce the speech representation 520. The user 104 may provide the textual input 112 via the user input to the user device 102. In some examples, the user 104 provides the textual input 112 directly by typing on a screen of the user device 102. In other examples, the user 104 may speak an utterance 106 such that the ASR model 200 generates the transcription 120 based on the utterance 106 which serves as the textual input 112. Without departing from the scope of the present disclosure, the textual input 112 may correspond to a response, notification, or other communication that a digital assistant is conveying to the user 104. The user 104 may also select a target embedding for use by the TTS model 501 in generating synthetic speech having speaker characteristics of a target speaker. Additionally or alternatively, the user 104 may further specify an intended prosody/style of the resulting synthetic speech. The audio subsystem 108 including a vocoder may receive the speech representation 520 and generate an audible output (e.g., via one or more speakers of the user device 102) of the textual input 112.

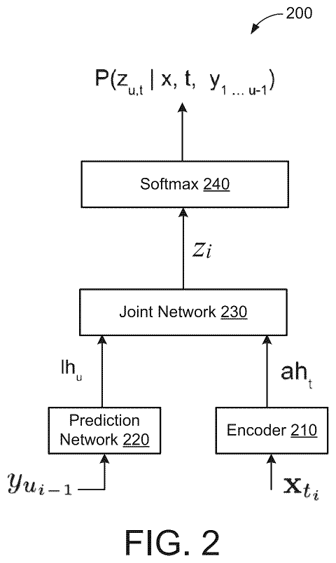

Referring to FIG. 2, in some examples, the ASR model 200 includes a Recurrent Neural Network-Transducer (RNN-T) model architecture which adheres to latency constraints associated with interactive applications. The use of the RNN-T model architecture is exemplary, and the ASR model 200 may include other architectures such as transformer-transducer and conformer-transducer model architectures among others. The RNN-T model architecture provides a small computation footprint and utilizes less memory requirements than conventional ASR architectures, making the RNN-T model architecture suitable for performing speech entirely on the user device 102 (e.g., no communication with a remote server is required). The RNN-T model architecture of the ASR model 200 includes an encoder network 210, a prediction network 220, and a joint network 230. The encoder network 210, which is roughly analogous to an acoustic model (AM) in a traditional ASR system, includes a stack of self-attention layers (e.g., Conformer or Transformer layers) or a recurrent network of stacked Long Short-Term Memory (LSTM) layers. For instance, the encoder network 210 reads a sequence of d-dimensional feature vectors (e.g., acoustic frames 110 (FIG. 1)) x=(x₁, x₂, . . . , x_{T}), where x₁∈ [symbol] _{d}, and produces at each output step a higher-order feature representation. This higher-order feature representation is denoted as h₁^{enc}, . . . , h_{T}^{enc}.

Similarly, the prediction network 220 is also an LSTM network, which, like a language model (LM), processes the sequence of non-blank symbols output by a final Softmax layer 240 so far, y₀, . . . , yᵤᵢ₋ᵢ, into a dense representation pᵤ_{ᵢ}. Finally, with the RNN-T model architecture, the representations produced by the encoder and prediction/decoder networks 210, 220 are combined by the joint network 230. The prediction network 220 may be replaced by an embedding look-up table to improve latency by outputting looked-up sparse embeddings in lieu of processing dense representations. The joint network then predicts P(yᵢ|xₜ_{ᵢ}, y₀, . . . , yᵤᵢ₋₁), which is a distribution over the next output symbol. Stated differently, the joint network 230 generates, at each output step (e.g., time step), a probability distribution over possible speech recognition hypotheses. Here, the “possible speech recognition hypotheses” correspond to a set of output labels each representing a symbol/character in a specified natural language. For example, when the natural language is English, the set of output labels may include twenty-seven (27) symbols, e.g., one label for each of the 24-letters in the English alphabet and one label designating a space. Accordingly, the joint network 230 may output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols), but the set of output labels is not so limited. For example, the set of output labels can include wordpieces, phonemes, and/or entire words, in addition to or instead of graphemes. The output distribution of the joint network 230 can include a posterior probability value for each of the different output labels. Thus, if there are 100 different output labels representing different graphemes or other symbols, the output y: of the joint network 230 can include 100 different probability values, one for each output label. The probability distribution can then be used to select and assign scores to candidate orthographic elements (e.g., graphemes, wordpieces, and/or words) in a beam search process (e.g., by the Softmax layer 240) for determining the transcription 120.

The Softmax layer 240 may employ any technique to select the output label/symbol with the highest probability in the distribution as the next output symbol predicted by the ASR model 200 at the corresponding output step. In this manner, the RNN-T model architecture of the ASR model 200 does not make a conditional independence assumption, rather the prediction of each symbol is conditioned not only on the acoustics but also on the sequence of labels output so far. The ASR model 200 does assume an output symbol is independent of future acoustic frames 110, which allows the RNN-T model architecture of the ASR model 200 to be employed in a streaming fashion.

In some examples, the encoder network (i.e., audio encoder) 210 of the ASR model 200 includes a stack of self-attention layers/blocks, such as conformer blocks. Here, each conformer block includes a series of multi-headed self-attention, depth wise convolution and feed-forward layers. The prediction network 220 may have two 2,048-dimensional LSTM layers, each of which is also followed by 440-dimensional projection layer. Alternatively, the prediction network 220 may include a stack of transformer or conformer blocks, or an embedding look-up table in lieu of LSTM layers. Finally, the joint network 230 may also have 440 hidden units. The Softmax layer 240 may be composed of a unified word piece or grapheme set that is generated using all unique word pieces or graphemes in a plurality of training data sets.

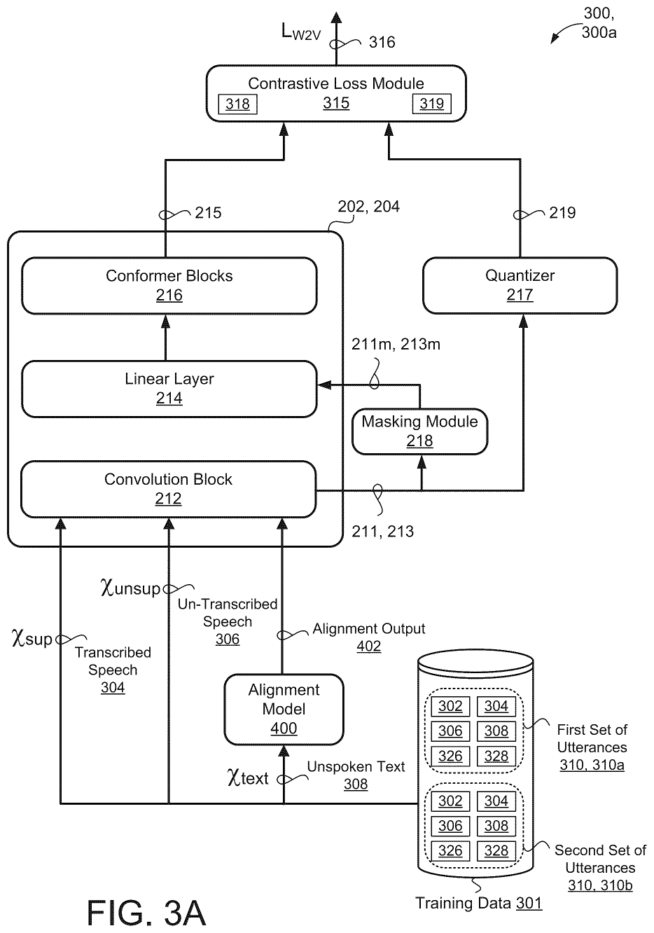

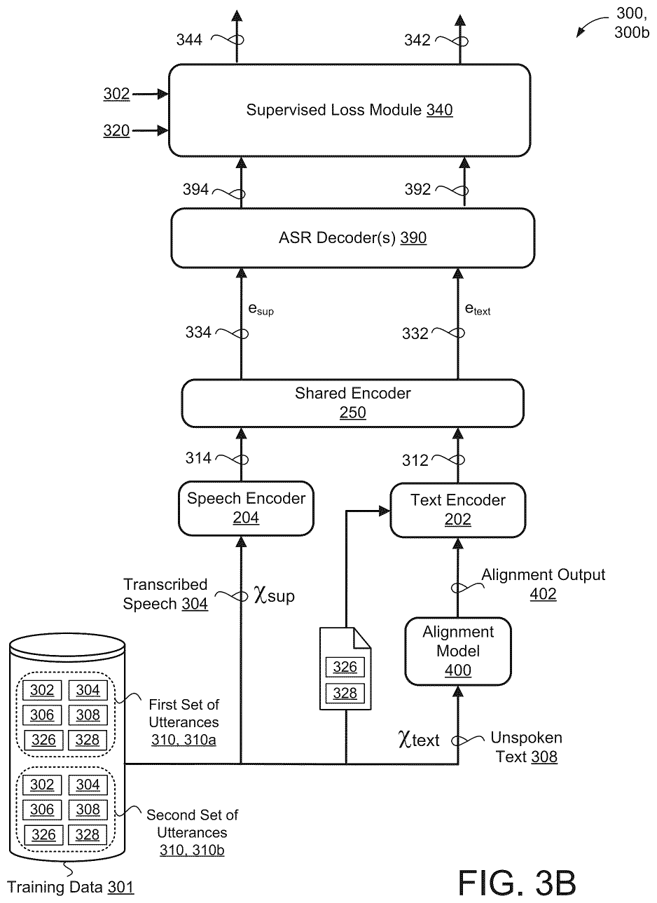

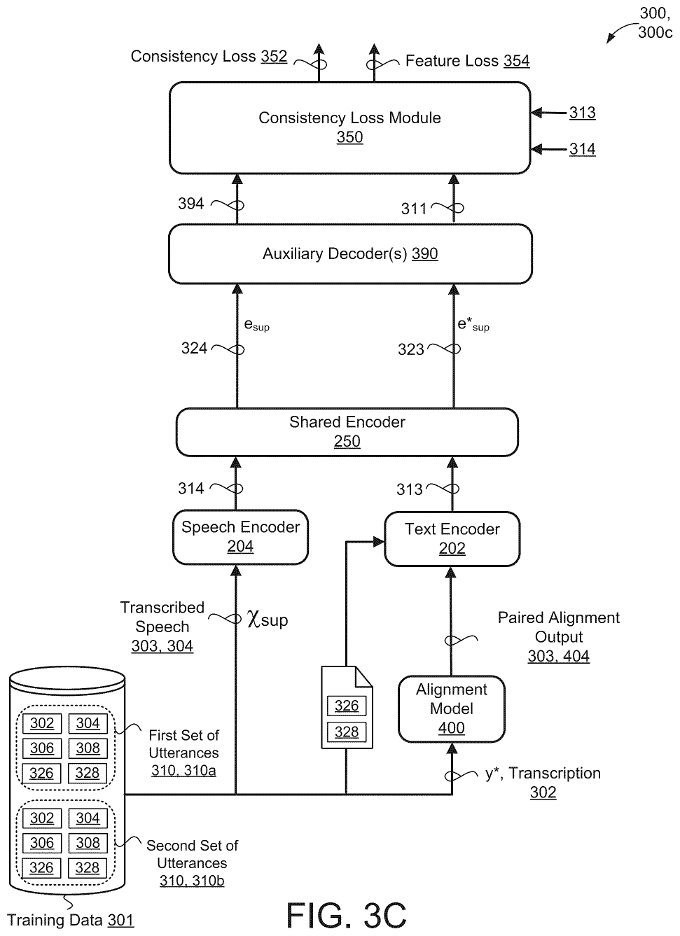

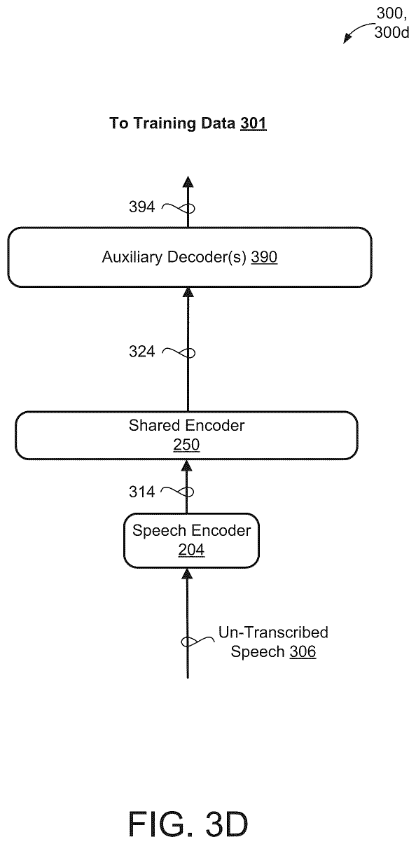

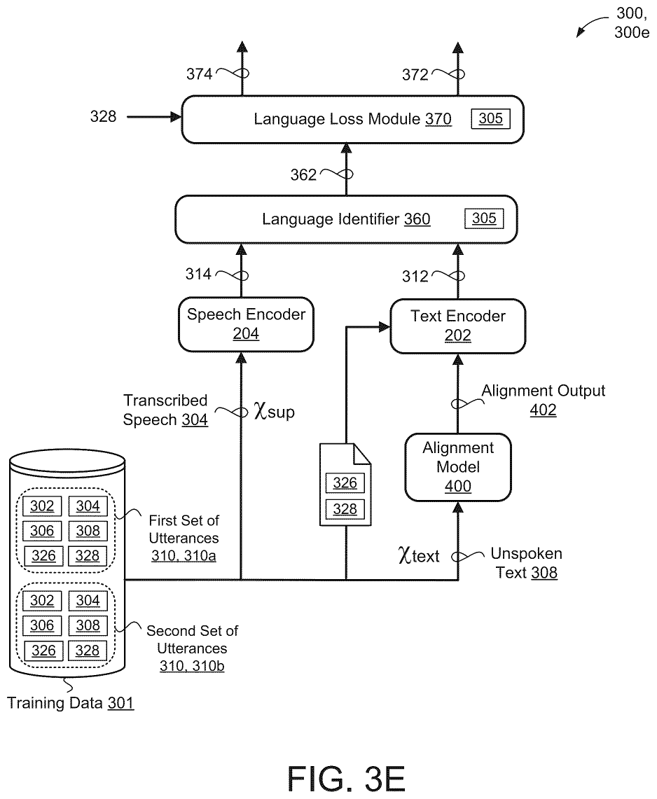

FIGS. 3A-3E illustrate an example training process 300 for training the TTS model 501 using sets of training utterances 310. In particular, the training process 300 may train a text encoder 202 of the TTS model 501. The TTS model 501 and the ASR model 200 may share the text encoder 202. As will become apparent, the training process 300 may train the TTS model 501 using training data 301 that includes a plurality of sets of training utterances 310. More specifically, each set of training utterances 310 of the plurality of sets of training utterances 310 includes a set of unspoken textual utterances (Xₜₑₓₜ) 308, a set of transcribed speech utterances (Xₛᵤₚ) 304, and/or un-transcribed speech utterances (Xᵤₙₛᵤₚ) 306. The set of transcribed speech utterance 304 and the set of un-transcribed speech utterances 306 may each include non-synthetic speech utterances spoken by a human and/or synthetic speech utterances generated by another TTS model. Each unspoken textual utterance 308 includes text-only data (i.e., unpaired data) such that each unspoken textual utterance 308 is not paired with any corresponding spoken audio representation (i.e., speech) of the utterance. The unspoken textual utterance 308 may include any sequence text chunks including words, word-pieces (i.e., word-piece-model units), phonemes, bytes, and/or graphemes. Since the unspoken textual utterances 308 are unspoken, each unspoken textual utterance 308 may be associated with a respective plurality of different languages. As will become apparent, the alignment model 400 may generate an alignment output 402 for the unspoken textual utterance 308 in one or more different languages. Each un-transcribed speech utterance (i.e., unpaired spoken utterance) 306 includes audio-only data (i.e., unpaired data) such that the un-transcribed speech utterance 306 is not paired with any corresponding transcription. On the other hand, each transcribed speech utterance 304 includes a corresponding transcription (i.e., input text sequence) 302 paired with a corresponding speech representation of the corresponding transcribed speech utterance 304.

Moreover, each set of training utterances 310 is associated with a respective language that is different than the respective language associated with each other set of the training utterances 310 and includes training utterances 310 of speech spoken in the respective language. For instance, in the example shown, the training data 301 includes a first set of training utterances 310, 310a including transcriptions 302, transcribed speech utterances 304, un-transcribed speech utterances 306, and unspoken textual utterances 308 each associated with a first respective language (e.g., English). Continuing with the example shown, the training data 301 also includes a second set of training utterances 310, 310b including transcriptions 302, transcribed speech utterances 304, un-transcribed speech utterances 306, and unspoken textual utterances 308 each associated with a second respective language (e.g., Chinese). The example shown includes two sets of training utterances 310 associated with two respective languages for the sake of clarity only, as it is understood that the training data 301 may include a number of sets of training utterances 310 associated with any number of languages.

For simplicity, the training process 300 includes a contrastive self-supervised loss part 300a (FIG. 3A), a supervised loss part 300b (FIG. 3B), and a consistency regularization part 300c (FIG. 3C). The training process 300 trains the TTS model 501 on a total loss (i.e., TTS loss 305) based on: contrastive losses (L_{w2v}) 316 derived using the contrastive self-supervised loss part 300a from the unspoken training text utterances (Xₜₑₓₜ) 308, a corpus of transcribed speech utterances (Xₛᵤₚ) 304, and un-transcribed speech utterances (Xᵤₙₛᵤₚ) 306; supervised losses (Lₐᵤₓ) 342, 344 derived using the supervised loss part 300b from the unspoken training text utterances (Xₜₑₓₜ) 306 and the transcribed speech utterances (Xₛᵤₚ) 304; consistency losses ( [symbol] _{cons}(θ)) 352 derived using the consistency regularization part 300c, and other losses determined by the training process discussed herein.

In some examples, the training process 300 employs an alignment model 400 that is configured to generate, at each of a plurality of output steps, alignment outputs (i.e., textual representation) 402 for a respective one of the plurality of unspoken training text utterances 308 and/or the transcriptions 302. Accordingly, the alignment model 400 may generate a corresponding alignment output 402 for each one of the unspoken textual utterances 308 and/or the transcriptions 302. Thereafter, the training process 300 trains the TTS model 501 using the generated alignment outputs 402.

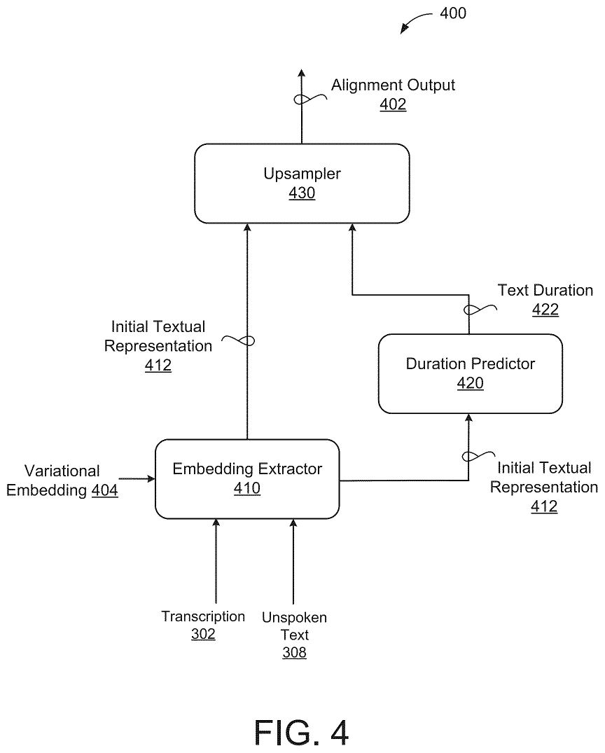

Referring now to FIG. 4, in some examples, the alignment model 400 includes an embedding extractor 410, duration predictor 420, and an upsampler 430. The embedding extractor 410 receives a respective one of the unspoken textual utterances 308 and/or the transcriptions 302. Here, the unspoken textual utterances 308 and the transcriptions 302 may each include a sequence of text chunks including words, word-pieces, phonemes, bytes, and/or graphemes. As such, the embedding extractor 410 extracts a corresponding initial textual representation (ex) 412 for the respective one of the unspoken textual utterances 308 and/or transcriptions 302. For example, the embedding extractor 410 may receive a respective transcription 302 and extract the initial textual representation (i.e., sequence representation) 412 from the respective transcription 302. The initial textual representation 412 includes embedding lexical information from the sequence of text chunks. In some examples, the embedding extractor 410 concatenates the initial textual representation 412 with a variational embedding 404 and provides the concatenation to the duration predictor (i.e., duration model) 420. The duration predictor 420 receives the initial textual representation 412 (or the concatenation) from the embedding extractor 410 and predicts a corresponding text chunk duration (i.e., word, word-piece, phoneme, and/or grapheme duration) 422. The text chunk duration 422 indicates a duration the corresponding text chunk would be spoken if a human (or text-to-speech system) spoke the respective transcription 302. For example, the transcription 302 may include a sequence of phonemes and the duration predictor 420 predicts a phoneme duration 422 for each phoneme in the sequence of phonemes. In this example, the duration predictor 420 predicts the phoneme duration 422 by predicting a probability of non-zero duration for each phoneme and predicting a probability of continuous phoneme duration for each phoneme. As the sequence of phonemes includes regular phonemes, silences between word boundaries, and punctuation marks, only the regular phonemes are associated with non-zero duration while the silences and punctuation marks are generally associated with the continuous phoneme duration. Accordingly, the duration predictor 420 may use a sigmoid activation following a first one of two independent activations to predict the probability of non-zero duration and use a soft plus activation following a second one of the two independent projections to predict the continuous text chunk duration 422 for each text chunk. The duration predictor 420 determines, for each text chunk, whether the probability of non-zero duration is less than a threshold value, and when the probability of non-zero duration is less than the threshold value, a multiplier may zero-out the continuous text chunk duration 422 predicted by the softplus activation for the corresponding text chunk. Otherwise, when the probability of non-zero duration is not less than the threshold value, the predicted text chunk duration 422 may be set equal to the continuous phoneme duration predicted by the softplus activation.

The upsampler 430 receives each corresponding initial textual representation 412 output by the embedding extractor 410 and the corresponding predicted text chunk duration 422, and generates an alignment output (et) 402 that has a number of frames by upsampling the initial textual representation 412 using the corresponding predicted text chunk duration 422. In some examples, the alignment model 400 sends the alignment output 402 to the text encoder 202. In other examples (not shown), the alignment model 400 sends the alignment output 402 to a shared encoder 250 (e.g., bypassing the text encoder 202) of the encoder 210. In these other examples, the alignment output 402 serves as the encoded textual representation 312 such that the shared encoder 250 may receive the alignment output 402 directly from the alignment model. In some additional examples, paired training data is available and the upsampler 430 generates the alignment output 402 as follows.

$${\hat{e}}_{t} = {θ}_{Refiner} ( Resample ( {e}_{t} , {Align}_{RNN - T} ( {e}_{s} , t ) ) ) \qquad ( 1 )$$

Here, the upsampler includes resampler and refiner layers that align the initial textual embedding 412 to align with a corresponding encoded audio representation 314 directly. In other examples, paired training data is not available and the upsampler 430 generates the alignment output 402 as follows.

$${\hat{e}}_{t} = {θ}_{Refiner} ( Resample ( {e}_{t} , {θ}_{duration} ( {e}_{t} ) ) ) \qquad ( 2 )$$

In particular, the number of frames of the alignment output 402 indicates a predicted speech duration of the respective one of the unspoken textual utterances 308 or transcriptions 302. Stated differently, the number of frames of the alignment output 402 maps (i.e., aligns) the sequence of text chunks of the text input to speech frames. Here, the upsampler 430 includes resampler and refiner layers that replicate the initial textual embedding 412 to match the predicted text chunk duration 422 (i.e., speech duration). As such, the alignment output 402 includes a textual representation of the text input (e.g., the unspoken textual utterances 308 and/or transcriptions 302) having a timing component that aligns with how a human would speak the text input.

Notably, in most instances, a TTS system (i.e., an auxiliary TTS system) generates an audible output to give text input the timing component of human speech such that a training process may use the audible output (i.e., synthetic speech) to train the encoder 210. Thus, since the alignment model 400 generates the alignment output 402 that maps the sequence of text chunks to speech frames directly, the training process 300 does not require speech synthesis of speech to generate the alignment outputs 402. That is, the alignment model 400 does not convert the input text into synthetic speech.

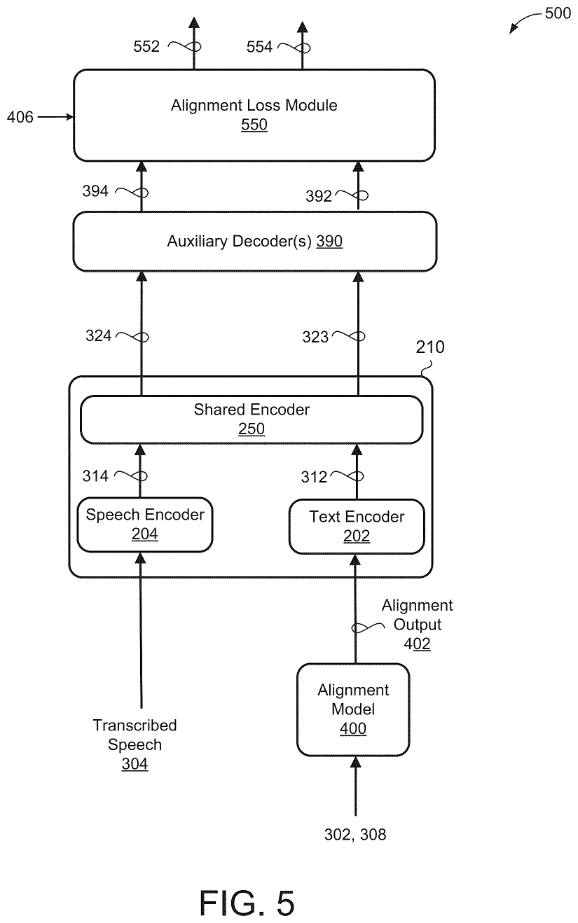

FIG. 5 illustrates an example training process 500 for training the alignment model 400 using paired training data and unpaired training data. That is, the training process 500 uses transcribed speech utterances 304 that have corresponding transcriptions 302 (i.e., paired training data) and unspoken textual utterances 308 (i.e., unpaired training data) to learn how to generate alignment outputs 402. In the example shown, the speech encoder 204 receives, as input, each transcribed speech utterance 304 as a sequence of features vectors (e.g., the acoustic frames 110 of FIG. 1) and generates, as output, for each of a plurality of output steps, an encoded audio representation (i.e., speech encoding) 314 that corresponds to the transcribed speech utterance 304 at the corresponding output step. When the speech encoder 204 generates the encoded audio representation 314 from un-transcribed speech 306, the encoded audio representation 314 represents an unpaired speech encoding 314. In parallel, the alignment model 400 receives the transcription 302 corresponding to the same transcribed speech utterance 304 and generates an alignment output 402 corresponding to the same transcribed speech utterance. Additionally or alternatively, the alignment model 400 may receive the unspoken textual utterance 308 and generate a corresponding alignment output 402. The text encoder 202 receives, as input, the alignment outputs 402 and generates, as output, for each of a plurality of output steps, an encoded textual representation 312. When the text encoder 202 generates the encoded textual representation 312 from an unspoken textual utterance 308, the encoded textual representation 312 represents an unspoken encoded textual representation 312.

The encoder 210 may include a shared encoder 250 that receives, as input, the encoded textual representations 312, and generates, as output, a first encoded shared representation 322. The shared encoder 250 may also receive, as input, the encoded audio representations 314 and generate, as output, a second encoded shared representation 324. An auxiliary decoder 390 receives, as input, the first and second encoded shared representations 322, 324 and generates, as output, corresponding first and second probability distributions 392, 294 over possible speech recognition hypotheses.

An alignment loss module 550 receives the first probability distribution 392 corresponding to the encoded textual representation 312 and the second probability distribution 394 corresponding to the encoded audio representation 314 and generates an alignment loss 552 by comparing the first probability distribution 392 to the second probability distribution 394. In some implementations, the alignment loss module 550 determines a duration loss 554. Here, the alignment loss module 550 may receive the alignment output 402 specifying the number of frames (FIG. 4) and a corresponding ground-truth duration 406 paired with the corresponding transcription 302 or unspoken textual utterance 308 from which the alignment output 402 was generated. That is, the ground-truth duration 406 may represent the number of frames the upsampled output or alignment output 402 should have such that the alignment loss module 550 determines the duration loss 554 by comparing the predicted duration 422 of the input text sequence 412 (FIG. 4) and the ground-truth duration 406. The training process 500 may train any combination of components of the alignment model 400 based on the alignment loss 552 and/or the duration loss 554 by updating parameters of the alignment model 400.

Referring now specifically to FIG. 3A, in some implementations, the encoder 210 includes a speech encoder 204 and the text encoder 202, described in more detail with reference to FIGS. 3B and 3C. In the example shown, the speech encoder 204 processes audio input (e.g., transcribed speech utterance 304 and un-transcribed speech utterances 306) and the text encoder 206 processes text input (e.g., unspoken text 308). Each of the speech encoder 204 and the text encoder 202 includes a Conformer encoder including a stack of conformer blocks each of which includes a series of multi-headed self attention, depth wise convolution, and feed-forward layers. Alternatively, the audio encoder 210 may include another type of encoder having a stack of self-attention layers/blocks, such as a transformer encoder. Each of the speech encoder 204 and the text encoder 202 may naturally be split into a feature encoder, including a convolution subsampling block 212, and a context network, including a linear layer 214 and a stack of Conformer blocks 216. In some implementations, the convolution subsampling block 212 has two two-dimensional-convolution layers, both with strides (2, 2), resulting in a 4× reduction in the feature sequence length. The convolution subsampling block 212 receives, as input, a sequence of input features/vectors (e.g., mel-frequency spectrograms such as the acoustic frames 110 of FIG. 1) associated with each transcribed speech utterance 304 and each un-transcribed speech utterance 306, and generates, as output, for each of a plurality of output steps, an encoded audio feature 211 that corresponds to a respective one of the transcribed speech utterances 304 or a respective one of the un-transcribed speech utterances 306. The convolution subsampling block 212 may receive, as input, each alignment output 402 and generate, as output, for each of the plurality of output steps, an encoded textual feature 213 that corresponds to a respective one of the alignment outputs 402.

The encoded audio and textual features 211, 213 (i.e., interchangeably referred to as “encoded features 211, 213”) output from the convolution subsampling block 212 may be fed to a masking module 218 where some of the encoded features 211, 213 are randomly chosen and replaced with a trained feature vector shared between all masked time steps to provide corresponding masked encoded audio features 211, 211m and masked encoded textual features 213, 213m. In some examples, the masking module 218 masks the randomly chosen encoded features 211, 213 for masking by randomly sampling without replacement a certain proportion p of all time steps to be start indices and then masks the subsequent M consecutive time steps from every sample index, whereby some spans may overlap. After masking is applied, the linear layer 214 and the Conformer blocks 216 of the context network receives the masked encoded features 211m (or encoded features 211, 213 not chosen by the masking module 218) and outputs corresponding contrastive context vectors (i.e., encoded representation) 215 from masked encoded features 211m, 213m. Moreover, a quantizer 217 receives the encoded features 211, 213 as input, and generates quantized vectors (i.e., target context vectors) 219 as output. In some implementations, the quantizer 217 applies random projections to project the corresponding utterance 310 (e.g., encodings 211, 213) using a random projection quantizer. Here, the quantizer 217 generates the target context vectors 219 by mapping the corresponding projected utterance to discrete labels. Thereafter, a contrastive loss module 315 derives a contrastive loss (L_{w2v}) 316 between the contrastive context vectors 215 at the masked positions and the target context vectors 219 as follows.

$${ℒ}_{w 2 v} = - log \frac{exp ( sim ( {c}_{t} , {q}_{t} ) / k )}{{\sum }_{\tilde{q} ∼ {Q}_{t}} ( sim ( {c}_{t ,} \tilde{q} ) / k )} \qquad ( 3 )$$

where cᵢ is contrastive context vector 215 centered over a masked time step t and qᵢ represents a target context vector 219 at the time step t in a set of K+1 candidate target context vectors 219 which includes qₜ and K distractors. Distractors may be uniformly sampled from other masked time steps of the same utterance.

The contrastive loss 316 is optimized between the contrastive context vectors 215 at the masked positions and the target context vectors 219. After the encoder 210 converges on the un-transcribed speech utterances 306, the training procedure is repeated on both the alignment outputs 402 corresponding to the unspoken textual utterance 308 and the transcribed speech utterances 304. Thus, the contrastive loss (Zwze) is optimized for both real/human and the unspoken textual utterances 308 represented by alignment outputs 402, with additional auxiliary losses on the transcribed speech utterances 304 and the alignment outputs 402 as described in greater detail below with reference to FIG. 3B. Accordingly, the contrastive part 300a of the training process 300 trains the speech encoder 204 and the text encoder 202 on the derived contrastive loss 316 applied on the corresponding encoded features 211, 213 associated with each alignment output 402, each transcribed speech utterance 304, and each un-transcribed speech utterance 306 provided as input to the encoder 210. Training the encoder 210 may include updating parameters of the encoder 210 based on the contrastive losses 316.

In some implementations, the contrastive loss module 315 determines an aligned-text masked language modeling (MLM) loss 318 and an aligned-speech MLM loss 319. Here, the contrastive loss module 315 determines the aligned-text MLM loss 318 for the alignment outputs 402 (e.g., generated from unspoken textual utterances 308) by comparing the contrastive context vector 315 generated from masked encoded features to the contrastive context vectors 219 generated from corresponding unmasked encoded features. That is, the contrastive loss module 315 determines the aligned-text MLM loss 318 by comparing the encodings generated for masked and unmasked encoded features for the alignment outputs 402. The contrastive loss module 315 determines the aligned-speech MLM loss 319 for the speech input (e g., transcribed speech utterance 304 and un-transcribed speech utterances 306) by comparing the contrastive context vector 215 generated from masked encoded features to contrastive context vectors 219 generated from corresponding unmasked encoded features. That is, the contrastive loss module 315 determines the aligned-speech MLM loss 319 by comparing the encodings generated for masked and unmasked encoded features for the speech inputs. The training process 300 may train the TTS model 501 based on the aligned-text MLM loss 318 and/or the aligned-speech MLM loss 319.

Referring now to FIG. 3B, the supervised loss part 300b of the training process 300 is configured to inject lexical information into the text encoder 204 of the TTS model 501 during pre-training based on supervised loss terms 342, 344 derived from the transcribed speech utterances 304 and the alignment outputs 402 corresponding to unspoken textual utterances 308 output by the alignment model 400. Notably, the supervised loss part 300b leverages one or more ASR decoders 390 for generating the supervised loss terms (i.e., ASR loss) 342, 344. The ASR decoders 390 may include Connectionist Temporal Classification (CTC) decoders, Listen Attend Spell (LAS) decoders, or RNN-T decoders (e.g., RNN-T architecture). These ASR decoders 390 may include at least one of a phoneme decoder configured to decode a sequence of phonemes or a wordpiece decoder configured to decode a sequence of word pieces. The ASR decoders 390 could also include a grapheme decoder configured to decode a sequence of graphemes.

During the supervised loss part 300b, the text encoder 202 is configured to receive alignment outputs 402 (i.e., text embeddings) from the alignment model 400 and the speech encoder 204 is configured to receive transcribed speech utterances 304. That is, the text encoder 202 generates encoded textual representations 312 for alignment outputs 402 (e.g., corresponding to an unspoken textual utterance 308) and the speech encoder 204 of the encoder 210 generates encoded audio representations 314 for speech inputs (i.e., transcribed speech utterances 304). Here, the encoded textual representations 312 and the encoded audio representations 314 may not both be compatible with the ASR decoders 390. In some examples, the text encoder 202 obtains a corresponding speaker embedding 326 that characterizes speaker characteristics of a corresponding speaker that spoke the training utterance in the respective language and generates the corresponding encoded textual representation 312 based on a concatenation of the corresponding alignment output 402 and the corresponding speaker embedding 326. When the training utterance 310 includes synthetic speech, the speaker embedding 326 may represent the embedding input to the TTS model that generated the training utterance 310 to produce the particular voice characteristics of the training utterance 310. Moreover, the text encoder 202 may obtain a corresponding language embedding 328 that identifies the respective language of the respective training utterance 310 in addition to, or in lieu of, the speaker embedding 326. The training process 300 may concatenate the speaker embedding 326 and the language embedding 328 and provide the concatenation as input to the text encoder 202 such that the text encoder generates the encoded textual representation 312 based on the alignment output 402 and the concatenation of the speaker embedding 326 and the language embedding 328.

Thus, the supervised loss part 300b may employ a shared encoder 250 that receives the encoded textual representations 312 as input, and generates a first encoded shared representation 322 (eₜₑₓₜ) as output. Similarly to the text encoder 202, the TTS model 501 and the ASR model 200 may share the shared encoder 250. Moreover, the shared encoder 250 receives the encoded audio representations 314 as input, and generates a second encoded shared representation (eₛᵤₚ) 324 as output. Accordingly, the shared encoder 250 generates the first and second encoded shared representations 322, 324 into a shared latent representation space compatible with the ASR decoder 390.

In particular, the shared encoder 250 receives, as input, each encoded textual representation 312 that corresponds to the alignment output 402 generated from the unspoken textual utterance 308 and generates, as output, for each of a plurality of time steps, the first encoded shared representation (eₜₑₓₜ) 322 that corresponds to the alignment output 402 at the corresponding output step. The ASR decoder 390 including the phoneme decoder or the wordpiece decoder receives, as input, each first encoded shared representation (i.e., shared encoder output) 332 output from the shared encoder 250 and generates, as output, a first probability distribution 392 over possible speech recognition hypotheses for the corresponding alignment output 402 at the corresponding output step. In some examples, the first probability distribution 392 over possible speech recognition hypotheses includes one of possible phoneme labels, possible word piece labels, or possible grapheme labels. Thus, the first probability distribution 392 over possible speech recognition hypotheses may represent a first speech recognition hypothesis that represents a candidate transcription for the corresponding training utterance 310. As such, the first probability distribution 392 may also be referred to as the first speech recognition hypothesis 392 herein. Thereafter, an supervised loss module 340 may determine an alignment output loss term 342 based on the first probability distribution 392 over possible speech recognition hypotheses for the alignment output 402 corresponding to the unspoken textual utterance 308. Here, the corresponding unspoken textual utterance 308 in which the alignment output 402 is generated from also serves as a ground-truth transcription 302. Since the alignment output 402 may be masked, the alignment output loss term 342 also serves as an aligned MLM loss. The supervised loss part 300b may train the text encoder 202 and/or speech encoder 204 on the alignment output loss term 342 by updating parameters of the text encoder 202 and/or the speech encoder 204 based on the alignment output loss term 342.

Similarly, during the supervised loss part 300b, the shared encoder 250 receives, as input, each transcribed encoded audio representation 314 that corresponds to the transcribed speech utterance 304 and generates, as output, for each of a plurality of time steps, a second encoded shared representation (eₛᵤₚ) 334 that corresponds to the transcribed speech utterance 304 at the corresponding time step. The ASR decoder 390 including the phoneme decoder or the wordpiece decoder receives, as input, each second encoded shared representation (i.e., shared encoder output) 334 output from the shared encoder 250 and generates, as output, a second probability distribution 394 over possible speech recognition hypotheses for the corresponding transcribed speech utterance 304 at the corresponding time step. In some examples, the second probability distribution 394 over possible speech recognition hypotheses includes the one of possible phoneme labels, the possible word piece labels, or the possible grapheme labels. Thus, the second probability distribution 394 over possible speech recognition hypotheses may represent a second speech recognition hypothesis that represents a candidate transcription for the corresponding training utterance 310. As such, the second probability distribution 394 may also be referred to as the second speech recognition hypothesis 394 herein. Thereafter, the supervised loss module 340 may determine a speech loss term 344 based on the second probability distribution 394 over possible speech recognition hypotheses and the corresponding transcription 302 paired with the transcribed speech utterance 304. Here, the corresponding transcription 302 serves as a ground-truth transcription and may include a sequence of target phonemes, target word pieces, and/or target graphemes. The supervised loss part 300b may train the text encoder 202 and/or speech encode 204 on the speech loss term 344 by updating parameters of the text encore 202 and/or speech encoder 204 based on the speech loss term 344.

The un-transcribed speech utterances 306 and the unspoken textual utterances 308 each correspond to “unpaired” training data whereby the contrastive loss (L_{w2v}) 316 derived from the unspoken textual utterances (Xₜₑₓₜ) 308 may be combined with the supervised loss [symbol] ₐᵤₓ associated with the alignment output loss term 342 to obtain an unspoken textual loss function, [symbol] ₜₑₓₜ, as follows.

$${𝒥}_{text} = {ℒ}_{w 2 v} ( x \vert {θ}_{e} ) + {ℒ}_{aux} ( y \vert x , {θ}_{e} , {θ}_{d} ) \qquad ( 4 )$$

Likewise, the contrastive loss (L_{w2v}) 316 derived from the un-transcribed speech utterances (Xᵤₙₛᵤₚ) 306 may be used to express an unsupervised speech loss function, [symbol] _{unsup_speech}, as follows.

$${𝒥}_{unsup \_ speech} = {𝒥}_{w 2 v} ( {x}^{*} \vert {θ}_{e} ) \qquad ( 5 )$$

During training of the text encoder 202 and the speech encoder 204, the alignment outputs 402 and the un-transcribed utterances 306 may be separated or mixed within each batch. In order to force the text encoder 202 to learn representations that are effective for both alignment outputs 402 corresponding to unspoken textual utterances 308 and (human/real) speech, the loss mask σ is applied when combining the loss functions [symbol] ₜₑₓₜ and of Equations. 5 and 6 to obtain an unpaired data loss function, [symbol] _{unpaired}, as follows.

$${𝒥}_{unpaired} = σ {𝒥}_{text} + ( 1 - σ ) {𝒥}_{speech} \qquad ( 6 )$$

The transcribed speech utterances 304 corresponds to “paired” and “supervised” training data whereby the derived contrastive loss L_{w2v} and the derived supervised loss [symbol] ₐᵤₓ associated with the speech loss term 344 may be combined to obtain a paired data loss function, [symbol] _{paired}, as follows.

$${𝒥}_{paired} = {ℒ}_{w 2 v} ( x \vert {θ}_{e} ) + {ℒ}_{a u x} ( y \vert x , {θ}_{e} , {θ}_{d} ) \qquad ( 7 )$$

Referring to FIG. 3C, the consistency regularization part (i.e., modality matching part) 300c of the training process 300 is configured to promote the text encoder 202 and the speech encoder 204 to learn consistent predictions between speech (e.g., real/human speech) and alignment outputs 402 corresponding to unspoken textual utterances 308 by generating a consistent loss term ( [symbol] _{cons}(θ)) 352 between training utterance pairs 303 that each include a corresponding one of the transcribed speech utterances (Xₛᵤₚ) 304 and a paired alignment output 404 of the same utterance as the corresponding transcribed speech utterance 304. As such, the speech utterance 304 and the paired alignment output 404 of each training utterance pair 303 is associated with a same ground-truth transcription. In short, the consistent loss term 352 between the transcribed speech utterance 304 and paired alignment output 404 of the same training utterance provides an unsupervised training aspect by encouraging the encoder 210 to behave consistently regardless of whether the training utterance belongs to speech (i.e., speech training data) or the alignment output (i.e., text training data) and independent of supervised loss terms between the ground-truth transcription 302 and each of: speech recognition hypotheses output by the auxiliary decoder 390; and speech recognition hypothesis output by the auxiliary decoder 390.

Similar to the alignment outputs 402 generated from the unspoken textual utterances 308 in FIG. 3B, the alignment model 400 may generate each paired alignment output 404 using the corresponding transcription 302 that is paired with the transcribed speech utterance 304. Here, the speech representation 304 is associated with paired alignment output 404 generated by the alignment model 400 mapping the unspoken textual utterance 308 into speech frames.

During the consistency regularization part 300c, the text encoder 202 receives, as input, each paired alignment output 404 and generates, as output, for each of a plurality of time steps, an encoded textual representation 313 that corresponds to the paired alignment output 404 at the corresponding output step. In some examples, the text encoder 202 obtains a corresponding speaker embedding 326 that characterizes speaker characteristics of a corresponding speaker that spoke the training utterance in the respective language and generates the corresponding encoded textual representation 312 based on a concatenation of the corresponding alignment output 402 and the corresponding speaker embedding 326. Moreover, the text encoder 202 may obtain a corresponding language embedding 328 that identifies the respective language of the respective training utterance 310 in addition to, or in lieu of, the speaker embedding 326. The training process 300 may concatenate the speaker embedding 326 and the language embedding 328 and provide the concatenation as input to the text encoder 202 such that the text encoder generates the encoded textual representation 312 based on the alignment output 402 and the concatenation of the speaker embedding 326 and the language embedding 328.

The shared encoder 250 receives, as input, the encoded textual representation 313 and generates, as output, a first encoded shared representation (e sup) 323. The auxiliary decoder 390 including the phoneme decoder or the wordpiece decoder receives, as input, each first encoded shared representation 323 output from the shared encoder 250 and generates, as output, a first probability distribution 311 over possible speech recognition hypotheses for the corresponding paired alignment output 404 at the corresponding output step. In some examples, the first probability distribution 311 over possible speech recognition hypotheses includes one of possible phoneme labels or possible word piece labels.

Similarly, the speech encoder 204 receives, as input, each transcribed speech utterance 304 as a sequence of features/vectors (e.g., mel-frequency spectrograms such as the acoustic frames 110 of FIG. 1) and generates, as output, for each of a plurality of time steps, an encoded audio representation 314 that corresponds to the transcribed speech utterance 304 at the corresponding output step. The shared encoder 250 receives, as input, the encoded audio representation 314 and generates, as output, a second encoded shared representation (eₛᵤₚ) 324. The auxiliary decoder 390 including the phoneme decoder or the wordpiece decoder receives, as input, each second encoded shared representation 324 output from the shared encoder 250 and generates, as output, a second probability distribution 394 over possible speech recognition hypotheses for the corresponding transcribed speech utterance 304 at the corresponding time step. In some examples, the second probability distribution 394 over possible speech recognition hypotheses includes the one of the possible phoneme labels or the possible word piece labels.

With continued reference to FIG. 3C, the consistency regularization part 300c of the training process 300 further determines, at each of the plurality of output steps for each training utterance pair 301, the consistent loss term ( [symbol] _{cons}(θ)) 352 for the corresponding training utterance pair 301 based on the first probability distribution 311 over possible speech recognition hypotheses and the second probability distribution 394 over possible speech recognition hypotheses. For instance, the training process 300 may employ a consistency loss term module 350 configured to receive, at each time step, the corresponding speech and speech recognition results 311, 394 output by the auxiliary decoder 390, and determine the consistency loss term 352 for the corresponding training utterance pair 301 at the time step.

In some examples, the consistency regularization part 300c of the training process 300 determines the consistent loss term 352 based on a Kullback-Leibler divergence (D_{KL}) between the first probability distribution 311 over possible speech recognition hypotheses and the second probability distribution 394 over possible speech recognition hypotheses. The consistent loss term 352 based on D_{KL} may be expressed by the following equation.

$${𝒥}_{cons} ( θ ) = {𝒟}_{K L} ( {p}_{\tilde{θ}} ( y \vert x ) ‖ {p}_{θ} ( y \vert \hat{x} ) ) \qquad ( 8 )$$

Here, the consistent loss term 352 determined for the training utterance pair 301 at each time step provides an “unsupervised” loss term that is independent of the accuracy of the auxiliary decoder 390 (e.g., independent of the supervised loss terms 342, 344 of FIG. 3B), and thus, may be employed to update parameters of the encoder 210 for promoting consistency between speech representations and alignment outputs of the same utterances. In batch training, the consistent loss term 352 may correspond to an average loss term obtained for the batch. In other words, the consistent loss term 352 permits the text encoder 202 and the speech encoder 204 to learn to behave the same, e.g., make consistent encoded representation predictions on both speech (e.g., real/human speech) and alignment outputs of a same training utterance, regardless of whether the training utterance belongs to speech or alignment outputs.

In some implementations, the consistency loss module 350 receives the encoded textual representations 313 generated by the text encoder 202 for the corresponding transcription 302 and the encoded audio representation (i.e., speech encodings) 314 generated by the speech encoder 204 for the corresponding reference speech representation (i.e., transcribed speech utterance) 304. Here, the training utterance pairs 303 correspond to the same training utterance 310, the consistency loss module 350 may determine a feature loss 354 between the encoded textual representation 313 and the speech encodings 314 corresponding to the same training utterance 310. Thus, the consistency loss module 350 determines feature loss 354 before decoding the encoded representations 313, 314 into speech recognition hypotheses. The training process 300 may train the TTS model 501 based on the feature loss 354 determined for each training utterance 310.

Lastly, the training process 300 may combine the unpaired data loss function ( [symbol] _{unpaired}), the paired data loss function ( [symbol] _{paired}), and the consistent loss term ( [symbol] _{cons}) to obtain an overall loss term, [symbol] ₜₜₛ₄ₚᵣₑₜᵣₐᵢₙ₂, that may be expressed as follows.

$${𝒥}_{tts 4 pretrain 2} = {𝒥}_{unpaired} + {λ}_{1} 𝒥 paired + {λ}_{2} {𝒥}_{c o n s} \qquad ( 9 )$$

where λ₁ may be equal to 1.0 and λ₂ is equal to 0.1. The training process 300 may pre-train the audio encoder speech encoder 204 and the text encoder 202 using the overall loss term, [symbol] ₜₜₛ₄ₚᵣₑₜᵣₐᵢₙ₂, by updating parameters of the speech encoder 204 and the text encoder 202 to effectively teach the speech encoder 204 and the text encoder 202 to learn shared representations between speech and text. After pre-training the speech encoder 204 and the text encoder 202, the training process 300 may fine-tune the pre-trained speech encoder 204 and the text encoder 202 on transcribed speech utterances that may include supervised training samples of both alignment outputs corresponding to unspoken textual utterance 308 and (e.g., human speech).

In some implementations, the training process 300 for pre-training the speech encoder 204 and the text encoder 202 applies encoder consistency regularization. Unlike decoder consistency regularization applied to auxiliary decoder(s) during the consistency regularization part 300c that requires hypothesized labels (e.g., transcripts 302 and unspoken textual utterances 308), encoder consistency regularization does not require hypothesized labels and therefore has the advantage being allowed to be applied to all the training data 304, 306, 308. Encoder consistency regularization may be applied via Hierarchical Contrastive consistency Regularization (HCCR) techniques where encoder activations e, e* from original/non-augmented and augmented speech are projected through an auxiliary network to generate z and z*. Thereafter, positive and negative pairs are constructive and a contrastive loss l_{t,z,z*} is calculated as follows.

$${l}_{t , z , {z}^{*}} = - log \frac{exp ( sim ( {z}_{t}^{*} , {z}_{t} ) / τ )}{{\sum }_{k = 1}^{T} exp ( sim ( {z}_{t}^{*} , {z}_{k} ) / τ )} \qquad ( 10 )$$

Specific to HCCR, a Convolutional Neural Network (CNN) projection network may calculate projections over increasing length segments of encoder activations e (30, 50, 120 ms) to yield 3 views (V) and draw negative examples from the same utterance for short segments, and from other utterances in the batches with 120 ms segments. Accordingly, an HCCR loss may be calculated over the transcribed speech utterances 304 (paired speech), the un-transcribed speech utterances 306 (unpaired speech), and the alignment outputs 402 generated from the unspoken textual utterances 308 as follows.

$${ℒ}_{enc \_ cons} = {\sum }_{v = 1}^{V} {\sum }_{t = 1}^{{T}^{( v )}} {l}_{t , {z}^{* ( v )} , {z}^{( v )}} \qquad ( 11 )$$

The HCCR loss calculated by Equation 11 may be added to Equation 9 with a coefficient of 1e-3 as part of the overall loss term, [symbol] ₜₜₛ₄ₚᵣₑₜᵣₐᵢₙ₂, for use in pre-training the speech encoder 204 and the text encoder 202.

In short, the training process 300 trains the TT'S model 501 using the sets of training utterances 310 by training the speech decoder 204, the text encoder 202, and/or the shared encoder 250 based on any of the losses derived by the training process 300. Even though the speech decoder 204 and the shared encoder 240 may not be employed by the TTS model 501 during inference, the training process 300 trains these components to learn better shared representations between speech and text thereby further training the TTS model 501 (e.g., text encoder 202 of the TTS model 501) to generate encodings that accurately represent human speech.

Referring now to FIG. 3D, in some implementations, the training process 300 includes a training data generation process 300, 300d. Here, the speech encoder 204 receives the un-transcribed speech utterances 306 and generates a corresponding unpaired speech encoding 314 for each respective un-transcribed speech utterance (i.e., unpaired speech utterance) 306. The shared encoder 250 receives the unpaired speech encodings 314 and generates a corresponding unpaired shared encoder output 324 for each respective unpaired speech encoding 314. The auxiliary decoder 390 generates a pseudo label 394 representing a candidate transcription for the corresponding unpaired spoken utterance 306. That is, the probability distribution 394 over possible speech recognition hypotheses may represent a single transcription such that the candidate transcription serves as a self-supervised label for the unpaired speech utterance 306. As such, the training process 300 may pair the pseudolabel 394 with the corresponding unpaired speech utterance 306 such that the pairing now represents a transcribed speech utterance 304 which is added to the training data 301.

Referring now to FIG. 3E, in some implementations, the training process 300 includes a language loss part 300, 300e. During the language loss part 300e, the text encoder 202 is configured to receive alignment outputs 402 (i.e., text embeddings) from the alignment model 400 and the speech encoder 204 is configured to receive transcribed speech utterances 304. That is, the text encoder 202 generates encoded textual representations 312 for alignment outputs 402 (e.g., corresponding to an unspoken textual utterance 308) and the speech encoder 204 of the encoder 210 generates encoded audio representations 314 for speech inputs (i.e., transcribed speech utterances 304). In some examples, the text encoder 202 obtains a corresponding speaker embedding 326 that characterizes speaker characteristics of a corresponding speaker that spoke the training utterance in the respective language and generates the corresponding encoded textual representation 312 based on a concatenation of the corresponding alignment output 402 and the corresponding speaker embedding 326. When the training utterance 310 includes synthetic speech, the speaker embedding 326 may represent the embedding input to the TTS model that generated the training utterance 310 to produce the particular voice characteristics of the training utterance 310. Moreover, the text encoder 202 may obtain a corresponding language embedding 328 that identifies the respective language of the respective training utterance 310 in addition to, or in lieu of, the speaker embedding 326. The training process 300 may concatenate the speaker embedding 326 and the language embedding 328 and provide the concatenation as input to the text encoder 202 such that the text encoder generates the encoded textual representation 312 based on the alignment output 402 and the concatenation of the speaker embedding 326 and the language embedding 328.

The language loss part 300e may include a language identifier 360. The language identifier 360 may be integrated into any component of the TTS model 501. For example, the language identifier 360 may be integrated into the encoder or the decoder of the TTS model 501. The language identifier 360 is configured to generate or predict a predicted language identifier 362 of the corresponding training utterance 310. That is, the language identifies may generate a predicted language identifier 362 based on the encoded textual representation 312 or generate a predicted language identifier 362 based on the encoded audio representation 314. Thereafter, a language loss module 370 may receive the predicted language identifier 362 predicted for each training utterance 310 and determined a text language identifier loss 372 or a speech language identifier loss 374. That is, predicted language identifiers 362 generated from encoded textual representations 312 may be compared with the corresponding language embeddings 328 paired with the training utterance 310 such that the language loss module 370 determines the text language identifier loss 372. Similarly, predicted language identifiers 362 generated from encoded audio representations 314 may be compared with the corresponding language embeddings 328 paired with the training utterance 310 such that the language loss module 370 determines the speech language identifier loss 374. The training process 300 may update parameters of the language identifier 360 and/or any other component of the TTS model 501 based on the language identifier losses 372, 374. Moreover, the training process 300 may determine a TTS loss (i.e., overall loss) 305 based on any combination of the losses determined during the training process 300. The example shown shows the language loss module 370 determining the TTS loss 305 by way of example only as any loss module may determine the TTS loss 305 and/or the training process 300 may combine each loss from the loss modules to determine the TTS loss 305. Thus, the TTS loss 305 may include any combination of losses determined during the training process 300 or the training process 500 (FIG. 5) such that the training process 300 may train the TTS model 501 by updating parameters of the TTS model 501 based on the TTS loss 305.

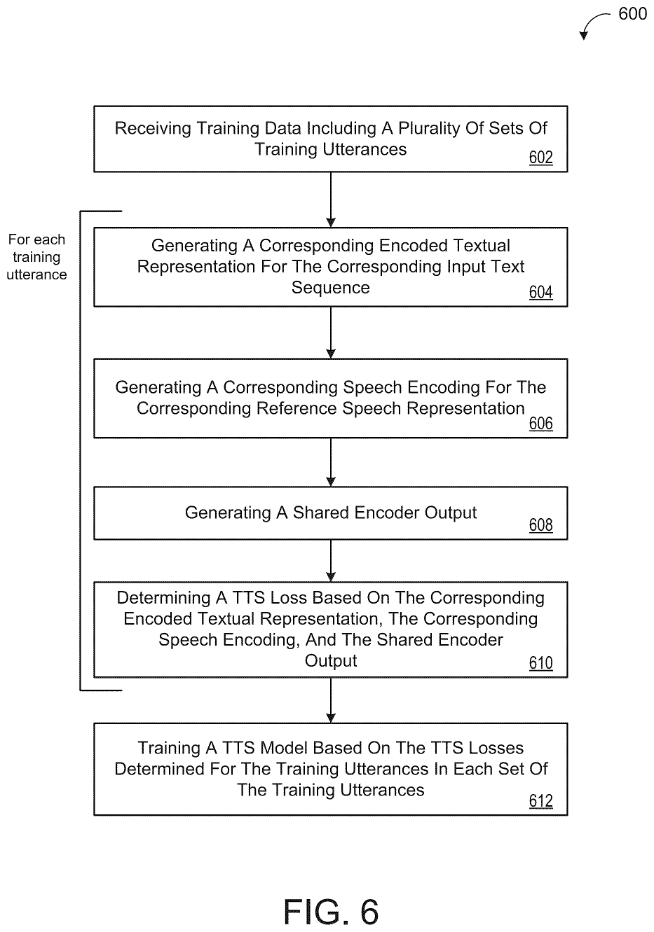

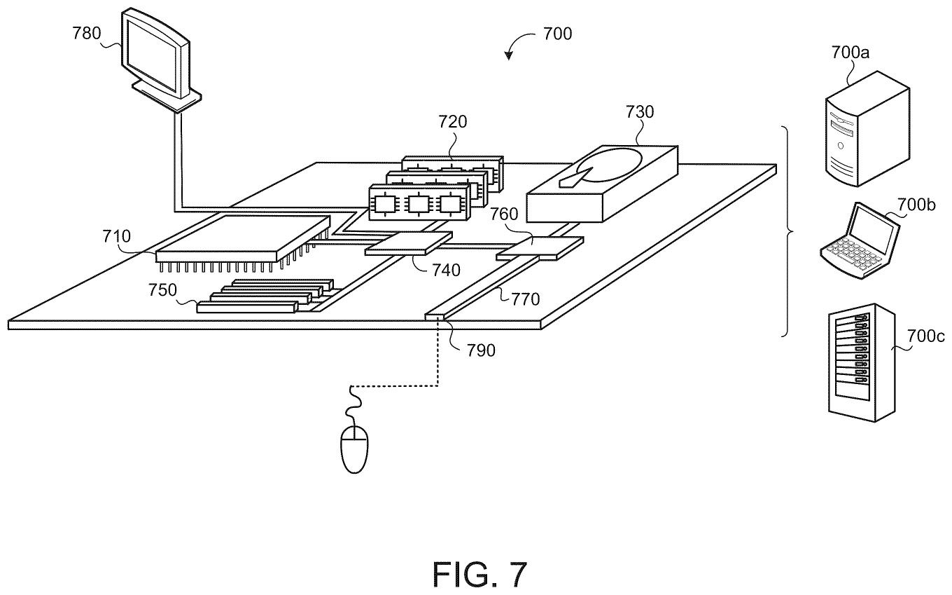

FIG. 6 is flowchart of an example arrangement of operations for a computer-implemented method 600 of massive multilingual speech-text joint semi-supervised learning for text-to-speech. The method 600 may execute on data processing hardware 710 (FIG. 7) using instructions stored on memory hardware 720 (FIG. 7). The data processing hardware 710 and the memory hardware 720 may reside on the user device 102 and/or the remote computing device 201 of FIG. 1 each corresponding to a computing device 700 (FIG. 7).

At operation 602, the method 600 includes receiving training data 301 that includes a plurality of sets of training utterances 310. Each set of training utterances 310 is associated with a respective language that is different than the respective language associated with each other set of the training utterances 310 and includes speech spoken in the respective language. Each training utterance 310 includes a corresponding reference speech representation 304 paired with a corresponding input text sequence 302. For each training utterance 310 in each set of training utterances 310 of the received training data 301, the method 600 performs operations 604-610. At operation 604, the method 600 includes generating a corresponding encoded textual representation 312, 313 for the corresponding input text sequence 302 using a text encoder 202. At operation 606, the method 600 includes generating a corresponding speech encoding 314 for the corresponding reference speech representation 304 using a speech encoder 204. At operation 608, the method 600 includes generating a shared encoder output 332, 334 using a shared encoder 250 configured to receive the corresponding encoded textual representation 312, 313 or the corresponding speech encoding 314. At operation 610, the method 600 includes determining a text-to-speech (TTS) loss 305 based on the corresponding encoded textual representation 312, 313, the corresponding speech encoding 314, and the shared encoder output 332, 334. At operation 612, the method 600 includes training a TTS model 501 based on the TTS losses 305 determined for the training utterances 310 in each set of the training utterances 310 to teach the TTS model to learn how to synthesize speech in each of the respective languages.

FIG. 7 is a schematic view of an example computing device 700 that may be used to implement the systems and methods described in this document. The computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 700 includes a processor 710, memory 720, a storage device 730, a high-speed interface/controller 740 connecting to the memory 720 and high-speed expansion ports 750, and a low speed interface/controller 740 connecting to a low speed bus 770 and a storage device 730. Each of the components 710, 720, 730, 740, 750, and 740, are interconnected using various busses, and may be mounted on a common motherboard or in other manners as appropriate. The processor 710 can process instructions for execution within the computing device 700, including instructions stored in the memory 720 or on the storage device 730 to display graphical information for a graphical user interface (GUI) on an external input/output device, such as display 780 coupled to high speed interface 740. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 720 stores information non-transitorily within the computing device 700. The memory 720 may be a computer-readable medium, a volatile memory unit(s), or non-volatile memory unit(s) The non-transitory memory 720 may be physical devices used to store programs (e.g., sequences of instructions) or data (e.g., program state information) on a temporary or permanent basis for use by the computing device 700. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 730 is capable of providing mass storage for the computing device 700. In some implementations, the storage device 730 is a computer-readable medium. In various different implementations, the storage device 730 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 720, the storage device 730, or memory on processor 710.

The high speed controller 740 manages bandwidth-intensive operations for the computing device 700, while the low speed controller 740 manages lower bandwidth-intensive operations. Such allocation of duties is exemplary only. In some implementations, the high-speed controller 740 is coupled to the memory 720, the display 780 (e.g., through a graphics processor or accelerator), and to the high-speed expansion ports 750, which may accept various expansion cards (not shown). In some implementations, the low-speed controller 740 is coupled to the storage device 730 and a low-speed expansion port 790. The low-speed expansion port 790, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 700a or multiple times in a group of such servers 700a, as a laptop computer 700b, or as part of a rack server system 700c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks, magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
receiving training data comprising a plurality of sets of training utterances, each set of training utterances associated with a respective language that is different than the respective language associated with each other set of the training utterances and comprising speech spoken in the respective language, each training utterance comprising a corresponding reference speech representation paired with a corresponding input text sequence;
for each training utterance in each set of training utterances of the received training data:
generating, using a text encoder, a corresponding encoded textual representation for the corresponding input text sequence;
generating, using a speech encoder, a corresponding speech encoding for the corresponding reference speech representation;
generating, using a shared encoder configured to receive the corresponding encoded textual representation or the corresponding speech encoding, a shared encoder output; and
determining a text-to-speech (TTS) loss based on the corresponding encoded textual representation, the corresponding speech encoding, and the shared encoder output; and
training a TTS model based on the TTS losses determined for the training utterances in each set of the training utterances to teach the TTS model to learn how to synthesize speech in each of the respective languages.

2. The computer-implemented method of claim 1, wherein the operations further comprise, for each training utterance in each set of the training utterances of the received training data:
obtaining a corresponding speaker embedding characterizing speaker characteristics of a corresponding speaker that spoke the training utterance in the respective language; and
obtaining a corresponding language embedding identifying the respective language of the utterance,
wherein the text encoder is configured to receive a concatenation of the corresponding speaker embedding and the corresponding language embedding.

3. The computer-implemented method of claim 1, wherein the operations further comprise, for each training utterance in each set of the training utterances of the received training data:
generating, using an automatic speech recognition (ASR) decoder configured to receive the shared encoder output as input, a speech recognition hypothesis representing a candidate transcription for the corresponding training utterance; and
determining an ASR loss based on the speech recognition hypothesis and the corresponding input text sequence,
wherein the TTS loss comprises the ASR loss.

4. The computer-implemented method of claim 3, wherein the ASR decoder comprises a recurrent neural network-transducer (RNN-T) architecture.

5. The computer-implemented method of claim 1, wherein the operations further comprise, for each training utterance in each set of the training utterances of the received training data:
determining a feature loss between the encoded textual representation generated for the corresponding input text sequence using the text encoder and the speech encodings generated for the corresponding reference speech representation using the speech encoder,
wherein the TTS loss comprises the feature loss.

6. The computer-implemented method of claim 1, wherein the operations further comprise, for each training utterance in each set of the training utterances of the received training data:
obtaining a sequence representation of the corresponding input text sequence concatenated with a variational embedding;
using a duration model:
predicting, based on the sequence representation, a duration of the input text sequence; and
upsampling, based on the duration of the input text sequence, the sequence representation into an upsampled output specifying a number of frames; and
determining a duration loss based on the predicted duration of the input text sequence and a ground-truth duration,
wherein the TTS loss comprises the duration loss.

7. The computer-implemented method of claim 1, wherein:
the training data further comprises unspoken textual utterances associated with a respective plurality of different languages, each unspoken textual utterance not paired with any corresponding spoken utterance; and
the operations further comprise, for each unspoken textual utterance:
generating, using the text encoder, a corresponding unspoken encoded textual representation for the corresponding unspoken textual utterance; and
determining an aligned-text masked language modeling (MLM) loss for the corresponding unspoken encoded textual representation generated for the corresponding unspoken textual utterance,
wherein the TTS loss comprises the aligned-text MLM loss.

8. The computer-implemented method of claim 7, wherein:
each unspoken textual utterance is paired with a corresponding language identifier label;
the operations further comprise, for each unspoken textual utterance:
generating, using a language identifier configured to receive the corresponding unspoken encoded textual representation generated for the corresponding unspoken textual utterance as input, a predicted language identifier; and
determining a text language identifier loss based on the predicted language identifier and the language identifier label,
wherein the TTS loss comprises the text language identifier loss.

9. The computer-implemented method of claim 1, wherein:
the training data further comprises unpaired spoken utterances spoken in a respective plurality of different languages, each unpaired spoken utterance not paired with any corresponding text; and
the operations further comprise, for each unpaired spoken utterance:
generating, using the speech encoder, a corresponding unpaired speech encoding for the corresponding unpaired spoken utterance; and
determining an aligned-speech masked language modeling (MLM) loss for the corresponding unpaired speech encoding generated for the corresponding unpaired spoken utterance,
wherein the TTS loss comprises the aligned-speech MLM loss.

10. The computer-implemented method of claim 9, wherein the operations further comprise, for each unpaired spoken utterance:
generating, using the shared encoder further configured to receive the corresponding unpaired speech encoding, an unpaired shared encoder output; and
generating, using an automatic speech recognition (ASR) decoder configured to receive the unpaired shared encoder output as input, a pseudolabel representing a candidate transcription for the corresponding unpaired spoken utterance,
wherein the training data further comprises unspoken textual utterances comprising the pseudolabels.

11. The computer-implemented method of claim 9, wherein:
each unpaired spoken utterance is paired with a corresponding language identifier label;
the operations further comprise, for each unpaired spoken utterance:
generating, using a language identifier configured to receive the corresponding unpaired speech encoding for the corresponding unpaired spoken utterance as input, a predicted language identifier; and
determining a speech language identifier loss based on the predicted language identifier and the language identifier label,
wherein the TTS loss comprises the speech language identifier loss.

12. The computer-implemented method of claim 1, wherein each corresponding input text sequence comprises a sequence of graphemes, word-piece-model units, phonemes, or bytes.

13. The computer-implemented method of claim 1, wherein generating the speech encoding for the corresponding reference speech representation comprises:
applying random projections to project the corresponding utterance using a random-projection quantizer; and
mapping the corresponding projected utterance to discrete labels.

14. A system comprising:
data processing hardware; and
memory hardware in communication with the data processing hardware, the memory hardware storing instructions that when executed on the data processing hardware cause the data processing hardware to perform operations comprising:
receiving training data comprising a plurality of sets of training utterances, each set of training utterances associated with a respective language that is different than the respective language associated with each other set of the training utterances and comprising speech spoken in the respective language, each training utterance comprising a corresponding reference speech representation paired with a corresponding input text sequence;
for each training utterance in each set of training utterances of the received training data:
generating, using a text encoder, a corresponding encoded textual representation for the corresponding input text sequence;
generating, using a speech encoder, a corresponding speech encoding for the corresponding reference speech representation;
generating, using a shared encoder configured to receive the corresponding encoded textual representation or the corresponding speech encoding, a shared encoder output; and
determining a text-to-speech (TTS) loss based on the corresponding encoded textual representation, the corresponding speech encoding, and the shared encoder output; and
training a TTS model based on the TTS losses determined for the training utterances in each set of the training utterances to teach the TTS model to learn how to synthesize speech in each of the respective languages.

15. The system of claim 14, wherein the operations further comprise, for each training utterance in each set of the training utterances of the received training data:
obtaining a corresponding speaker embedding characterizing speaker characteristics of a corresponding speaker that spoke the training utterance in the respective language; and
obtaining a corresponding language embedding identifying the respective language of the utterance,
wherein the text encoder is configured to receive a concatenation of the corresponding speaker embedding and the corresponding language embedding.

16. The system of claim 14, wherein the operations further comprise, for each training utterance in each set of the training utterances of the received training data:
generating, using an automatic speech recognition (ASR) decoder configured to receive the shared encoder output as input, a speech recognition hypothesis representing a candidate transcription for the corresponding training utterance; and
determining an ASR loss based on the speech recognition hypothesis and the corresponding input text sequence,
wherein the TTS loss comprises the ASR loss.

17. The system of claim 16, wherein the ASR decoder comprises a recurrent neural network-transducer (RNN-T) architecture.

18. The system of claim 14, wherein the operations further comprise, for each training utterance in each set of the training utterances of the received training data:
determining a feature loss between the encoded textual representation generated for the corresponding input text sequence using the text encoder and the speech encodings generated for the corresponding reference speech representation using the speech encoder,
wherein the TTS loss comprises the feature loss.

19. The system of claim 14, wherein the operations further comprise, for each training utterance in each set of the training utterances of the received training data:
obtaining a sequence representation of the corresponding input text sequence concatenated with a variational embedding;
using a duration model:
predicting, based on the sequence representation, a duration of the input text sequence; and
upsampling, based on the duration of the input text sequence, the sequence representation into an upsampled output specifying a number of frames; and
determining a duration loss based on the predicted duration of the input text sequence and a ground-truth duration,
wherein the TTS loss comprises the duration loss.

20. The system of claim 14, wherein:
the training data further comprises unspoken textual utterances associated with a respective plurality of different languages, each unspoken textual utterance not paired with any corresponding spoken utterance; and
the operations further comprise, for each unspoken textual utterance:
generating, using the text encoder, a corresponding unspoken encoded textual representation for the corresponding unspoken textual utterance; and
determining an aligned-text masked language modeling (MLM) loss for the corresponding unspoken encoded textual representation generated for the corresponding unspoken textual utterance,
wherein the TTS loss comprises the aligned-text MLM loss.

21. The system of claim 20, wherein:
each unspoken textual utterance is paired with a corresponding language identifier label;
the operations further comprise, for each unspoken textual utterance:
generating, using a language identifier configured to receive the corresponding unspoken encoded textual representation generated for the corresponding unspoken textual utterance as input, a predicted language identifier; and
determining a text language identifier loss based on the predicted language identifier and the language identifier label,
wherein the TTS loss comprises the text language identifier loss.

22. The system of claim 14, wherein:
the training data further comprises unpaired spoken utterances spoken in a respective plurality of different languages, each unpaired spoken utterance not paired with any corresponding text; and
the operations further comprise, for each unpaired spoken utterance:
generating, using the speech encoder, a corresponding unpaired speech encoding for the corresponding unpaired spoken utterance; and
determining an aligned-speech masked language modeling (MLM) loss for the corresponding unpaired speech encoding generated for the corresponding unpaired spoken utterance,
wherein the TTS loss comprises the aligned-speech MLM loss.

23. The system of claim 22, wherein the operations further comprise, for each unpaired spoken utterance:
generating, using the shared encoder further configured to receive the corresponding unpaired speech encoding, an unpaired shared encoder output; and
generating, using an automatic speech recognition (ASR) decoder configured to receive the unpaired shared encoder output as input, a pseudolabel representing a candidate transcription for the corresponding unpaired spoken utterance,
wherein the training data further comprises unspoken textual utterances comprising the pseudolabels.

24. The system of claim 22, wherein:
each unpaired spoken utterance is paired with a corresponding language identifier label;
the operations further comprise, for each unpaired spoken utterance:
generating, using a language identifier configured to receive the corresponding unpaired speech encoding for the corresponding unpaired spoken utterance as input, a predicted language identifier; and
determining a speech language identifier loss based on the predicted language identifier and the language identifier label,
wherein the TTS loss comprises the speech language identifier loss.

25. The system of claim 14, wherein each corresponding input text sequence comprises a sequence of graphemes, word-piece-model units, phonemes, or bytes.

26. The system of claim 14, wherein generating the speech encoding for the corresponding reference speech representation comprises:
applying random projections to project the corresponding utterance using a random-projection quantizer; and
mapping the corresponding projected utterance to discrete labels.
